(19) United States
(12) Patent Application Publication
(10) Pub. No.: US 2026/0178103 A1
(43) Pub. Date: Jun. 25, 2026

(54) COMMUNICATION BUS WITH POWER SAVINGS

(71) Applicant: QUALCOMM Incorporated, San Diego, CA (US)

(72) Inventors: Yasser Ahmed, San Diego, CA (US); Sachin Ajit Devamare, San Diego, CA (US)

(21) Appl. No.: 18/989,596

(22) Filed: Dec. 20, 2024

(51) Int. Cl. G06F 1/3234; G06F 1/3209; G06F 1/3228

(52) U.S. Cl. CPC G06F 1/3253; G06F 1/3209; G06F 1/3228; G06F 1/3265

(57) ABSTRACT

Communication buses with power-saving techniques applied are disclosed. In particular, in certain MIPI Alliance standards, such as, for example, the CPHY or the DPHY standards, are defined low-power modes. Aspects of the present disclosure contemplate turning off logic elements in a control circuit during such low-power modes to reduce power consumption that otherwise might occur. Further aspects of the present disclosure contemplate a variety of ways to select an appropriate amount of time for which the logic elements may be turned off in such low-power modes.

### TECHNICAL FIELD

The technology of the disclosure relates generally to communication buses such as those promulgated by MIPI and, more particularly, to techniques to save power consumed through the operation of such communication buses.

### BACKGROUND

Computing devices abound in modern society, and more particularly, mobile communication devices have become increasingly common. The prevalence of these mobile communication devices is partly driven by the many functions now enabled on such devices. Increased processing capabilities in such devices means that mobile communication devices have evolved from pure communication tools into sophisticated mobile entertainment centers, thus enabling enhanced user experiences. With the pressure to provide more functions, specialized devices such as cameras and high-quality displays have been integrated into mobile communication devices. Given the mobile nature of these communication devices, many are battery-powered, and there is continual pressure to find ways to save power so that the time between recharging is extended. Finding power-saving opportunities in devices that use components such as cameras and displays provides room for innovation.

### SUMMARY

Aspects disclosed in the detailed description include communication buses with power-saving techniques applied. In particular, in certain MIPI Alliance standards, such as, for example, the CPHY or the DPHY standards, are defined low-power modes. Aspects of the present disclosure contemplate turning off logic elements in a control circuit during such low-power modes to reduce power consumption that otherwise might occur. Further aspects of the present disclosure contemplate a variety of ways to select an appropriate amount of time for which the logic elements may be turned off in such low-power modes.

In this regard, in one aspect, a device is disclosed. The device includes a physical layer (PHY) comprising a bus interface configured to be coupled to a communication bus and a finite state machine (FSM) coupled to the bus interface, the FSM comprising internal logic elements. The FSM configured to, responsive to entering a low-power state on the communication bus, disable the internal logic elements and start a timer, and responsive to the timer expiring, enable the internal logic elements.

In another aspect, a mobile communication device is disclosed. The mobile communication device includes an endpoint, a communication bus coupled to the endpoint, and an application processor coupled to the communication bus. Wherein the endpoint comprises a PHY comprising a bus interface coupled to the communication bus and a FSM coupled to the bus interface, the FSM comprising internal logic elements. The FSM configured to, responsive to entering a low-power state on the communication bus, disable the internal logic elements and start a timer, and responsive to the timer expiring, enable the internal logic elements.

In another aspect, a method of determining a safe low-power window for a communication bus is disclosed. The method includes detecting entry of the communication bus into a low-power state, measuring how long the low-power state is maintained on the communication bus to determine a low-power window, and subtracting a pessimism window from the low-power window to determine the safe low-power window.

### BRIEF DESCRIPTION OF THE DRAWINGS

FIG. 1 is a block diagram of an exemplary mobile communication device with various MIPI communication buses contained therein;

FIG. 2 is an exemplary signal stream for a CPHY communication bus illustrating the low-power state;

FIG. 3 is an exemplary signal stream for a DPHY communication bus illustrating the low-power state;

FIG. 4 is a block diagram of a CPHY endpoint with a register for storing a sleep window for low-power states according to aspects of the present disclosure;

FIG. 5 is a block diagram of a DPHY endpoint with a register for storing a sleep window for low-power states according to aspects of the present disclosure;

FIG. 6 is a graph of a low-power window with the power-saving margins applied; and

FIG. 7 is a flowchart of a process for finding the duration of the low-power window to apply the power-saving technique of the present disclosure.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include communication buses with power-saving techniques applied. In particular, in certain MIPI Alliance standards, such as, for example, the CPHY or the DPHY standards, are defined low-power modes. Aspects of the present disclosure contemplate turning off logic elements in a control circuit during such low-power modes to reduce power consumption that otherwise might occur. Further aspects of the present disclosure contemplate a variety of ways to select an appropriate amount of time for which the logic elements may be turned off in such low-power modes.

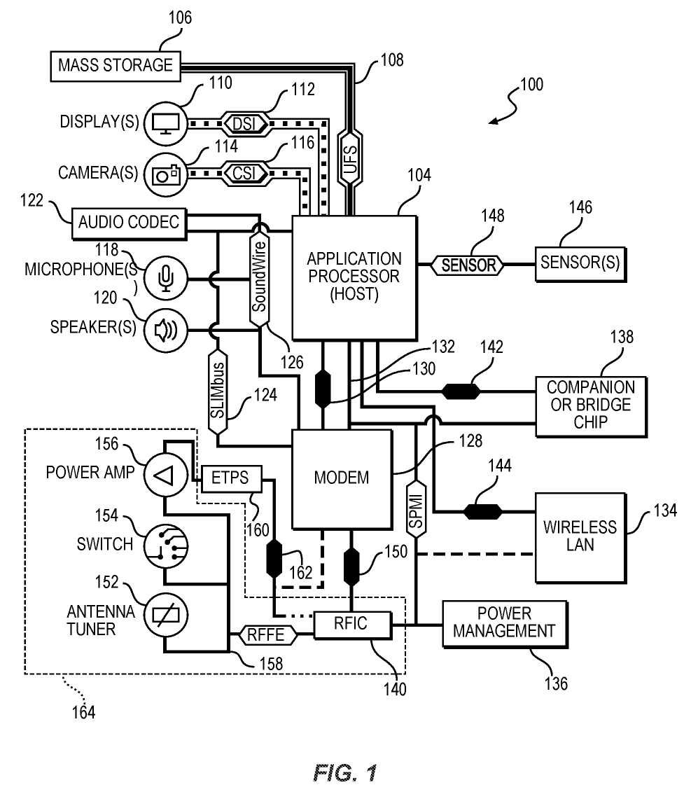

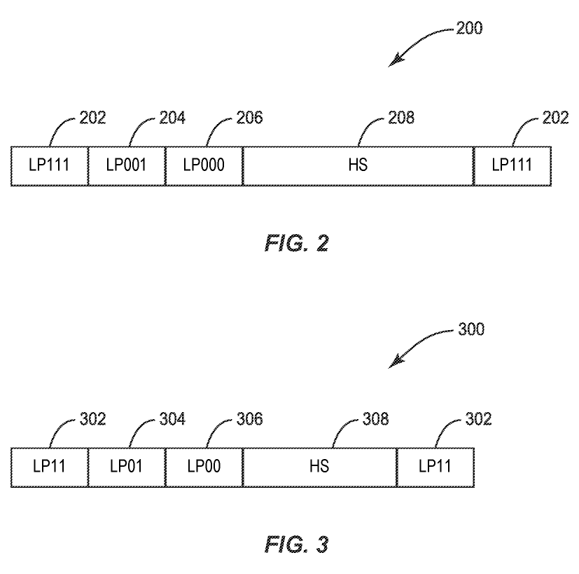

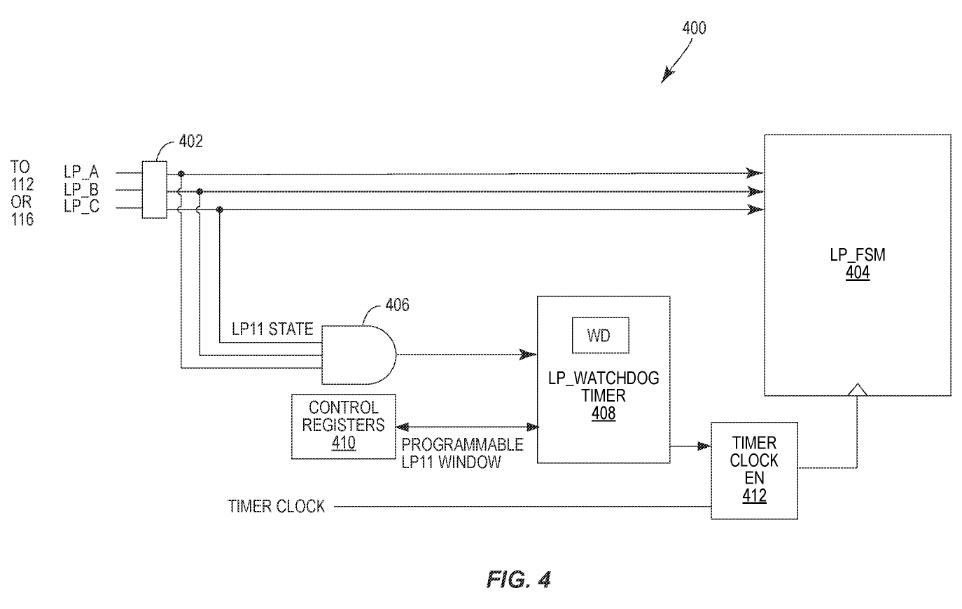

Before addressing aspects of the present disclosure, a brief discussion of a communication device and various communication buses internal thereto is provided with reference to FIG. 1. FIGS. 2 and 3 illustrate signal streams over two of the communication buses of the communication device. A discussion of aspects of the present disclosure begins below with reference to FIG. 4.

In this regard, FIG. 1 is a system-level block diagram of an exemplary mobile terminal 100, such as a smartphone, mobile computing device tablet, or the like. While a mobile terminal having a CPHY and/or a DPHY bus is particularly contemplated as being capable of benefiting from exemplary aspects of the present disclosure, it should be appreciated that the present disclosure is not so limited and may be useful in any system having a time division multiplexed (TDM) bus.

With continued reference to FIG. 1, the mobile terminal 100 includes an application processor 104 (sometimes referred to as a host) that communicates with a mass storage element 106 through a universal flash storage (UFS) bus 108. The application processor 104 may further be connected to a display 110 through a display serial interface (DSI) bus 112 and a camera 114 through a camera serial interface (CSI) bus 116. The buses 112 and 116 may be, for example, CPHY or DPHY communication buses. Various audio elements such as a microphone 118, a speaker 120, and an audio codec 122 may be coupled to the application processor 104 through a serial low-power interchip multimedia bus (SLIMbus) 124. Additionally, the audio elements may communicate with each other through a SOUNDWIRE bus 126. A modem 128 may also be coupled to the SLIMbus 124 and/or the SOUNDWIRE bus 126. The modem 128 may further be connected to the application processor 104 through a peripheral component interconnect (PCI) or PCI express (PCIe) bus 130 and/or a system power management interface (SPMI) bus 132.

With continued reference to FIG. 1, the SPMI bus 132 may also be coupled to a local area network (LAN or WLAN) IC (LAN IC or WLAN IC) 134, a power management integrated circuit (PMIC) 136, a companion IC (sometimes referred to as a bridge chip) 138, and a radio frequency IC (RFIC) 140. It should be appreciated that separate PCI buses 142 and 144 may also couple the application processor 104 to the companion IC 138 and the WLAN IC 134. The application processor 104 may further be connected to sensors 146 through a sensor bus 148. The modem 128 and the RFIC 140 may communicate using a bus 150.

With continued reference to FIG. 1, the RFIC 140 may couple to one or more RFFE elements, such as an antenna tuner 152, a switch 154, and a power amplifier 156 through a radio frequency front end (RFFE) bus 158. Additionally, the RFIC 140 may couple to an envelope tracking power supply (ETPS) 160 through a bus 162, and the ETPS 160 may communicate with the power amplifier 156. Collectively, the RFFE elements, including the RFIC 140, may be considered an RFFE system 164. It should be appreciated that the RFFE bus 158 may be formed from a clock line and a data line (not illustrated).

FIG. 2 shows part of an exemplary stream 200 that may occur over a CPHY communication bus (e.g., bus 112 or 116). In particular, the stream 200 may include a low-power state (LP111) 202, where no data is transmitted or received; a bridge low-power state (LP001) 204, where certain command and control information is sent; and a high-speed state (LP000) 206 where the bus settles, a preamble is sent, followed by a sync word, and then data (generally at 208). The high-speed state is followed by another low-power state LP111202. The bus will go in and out of the low-power state even when there is no traffic on the bus. For example, sync words and other command information may be exchanged periodically so that the device (display 110 or camera 114) remains connected to the application processor 104. Saliently, the duration of the low-power state 202 is always the same duration. That is, the low-power state 202 will not last longer than this duration so the aforementioned synchronization may occur at the proper time.

Similarly, FIG. 3 shows part of an exemplary stream 300 that may occur over a DPHY communication bus (e.g., bus 112 or 116). In particular, the stream 300 may include a low-power state (LP11) 302, where no data is transmitted or received; a bridge low-power state (LP01) 304, where certain command and control information is sent; and a high-speed state (LP00) 306 where the bus settles, a preamble is sent, followed by a sync word, and then data (generally at 308). The high-speed state is followed by another low-power state LP11302. The bus will go in and out of the low-power state even when there is no traffic on the bus. For example, sync words and other command information may be exchanged periodically so that the device (display 110 or camera 114) remains connected to the application processor 104. Saliently, the duration of the low-power state 302 is always the same duration. That is, the low-power state 302 will not last longer than this duration so that the aforementioned synchronization occurs at the proper time.

It should be noted that the MIPI standards for CPHY and DPHY require that even when the low-power state (i.e., LP111 or LP11) is present, a timer clock is still active and still causing logic elements within a finite state machine (FSM) to flop. That is, FSM are essentially built using flip-flop circuits that “flop” each time a clock transition is received. Thus, within the FSM, the presence of the timer clock is causing these flip-flop logic elements to toggle state with each clock transition. It is not uncommon for more than one thousand flops to occur during a low-power period. Given that a typical CPHY or DPHY bus spends approximately 65-80% of its time in a low-power state, these flops represent a significant contribution to the power consumption of the bus. While there may be some reasons to have some parts of the FSM active, the bulk of these flops serve no real purpose and may be considered wasted energy. As such, these flops are ripe for reduction to save power in the device and extend the time between battery charging.

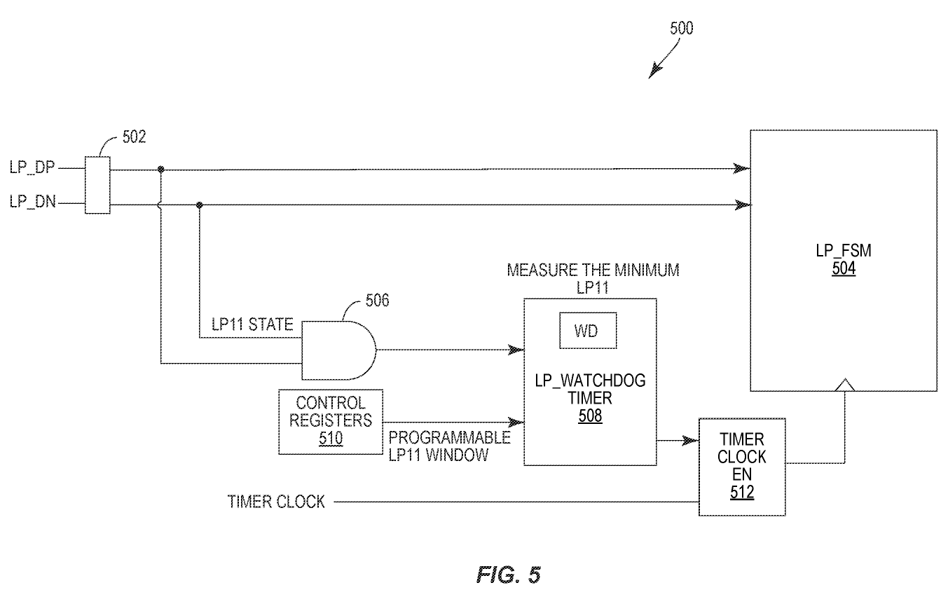

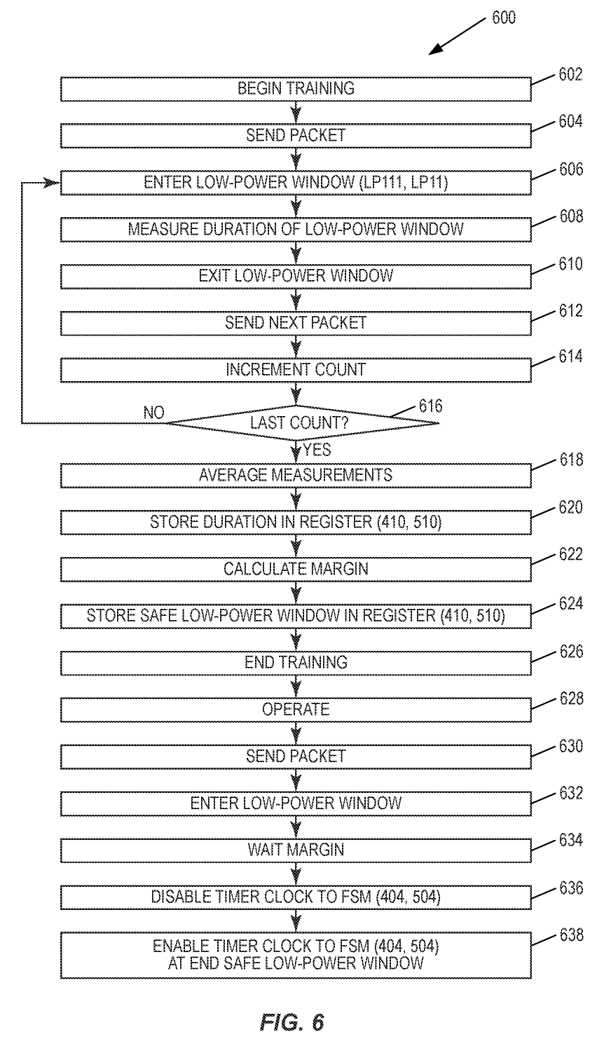

Exemplary aspects of the present disclosure determine the duration of the low-power window, subtract a safety margin (sometimes referred to as a pessimism margin) to create a safe low-power window, and then disable a timer clock signal to the logic elements of the FSM for future safe low-power windows within future low-power windows. The process for finding the low-power window may be a manual measurement or result of programming at the time of device creation or may be determined empirically after device integration. This process is discussed below with reference to FIG. 6. The relevant structures of the buses 112, 116 are discussed below with reference to FIGS. 4 and 5.

In this regard, FIG. 4 illustrates a device 400, which may be the display 110, camera 114, or the application processor 104. The device 400 includes a bus interface 402 configured to be coupled to a communication bus, such as bus 112 or 116. In this example, the bus is a CPHY communication bus, which has three lanes as defined by the CPHY protocol published by MIPI. The three lanes are coupled to an FSM 404 through the bus interface 402. The FSM 404 contains various digital logic elements (not shown, but elements such as inverters, AND gates, OR gates, buffers, and the like). The lanes are also coupled to an AND gate 406. The AND gate 406 is coupled to a low-power watchdog timer 408. When the low-power state is present, all the lines are set at a logical one (hence the LP111 moniker), and the AND gate 406 will output a logical one to the watchdog timer 408. The watchdog timer 408 is associated with one or more control registers 410 in which a low-power window (and/or a safe low-power window) duration may be stored as explained below. The watchdog timer 408 is also coupled to a timer clock enable circuit 412. The timer clock enable circuit 412 receives a clock signal and blocks the clock signal to the FSM 404 while the safe low-power window is operating and passes the clocks signal to the FSM 404 while the safe low-power window is not operating.

FIG. 5 is similar, but for a device 500 that is coupled to a DPHY communication bus. The device 500 may be the display 110, camera 114, or the application processor 104. The device 500 includes a bus interface 502 configured to be coupled to a communication bus such as bus 112 or 116. In this example, the bus is a DPHY communication bus, which has two lanes as defined by the DPHY protocol published by MIPI. The two lanes are coupled to an FSM 504 through the bus interface 502. The FSM 504 is similar to the FSM 404 and contains various digital logic elements (not shown, but elements such as inverters, AND gates, OR gates, buffers, and the like). The lanes are also coupled to an AND gate 506. The AND gate 506 is coupled to a low-power watchdog timer 508. When the low-power state is present, all the lines are set at a logical one (hence the LP11 moniker), and the AND gate 506 will output a logical one to the watchdog timer 508. The watchdog timer 508 is associated with one or more control registers 510 in which a low-power window (and/or a safe low-power window) duration may be stored as explained below. The watchdog timer 508 is also coupled to a timer clock enable circuit 512. The timer clock enable circuit 512 receives a clock signal and blocks the clock signal to the FSM 504 while the safe low-power window is operating and passes the clocks signal to the FSM 504 while the safe low-power window is not operating.

Aspects of the present disclosure take the knowledge that the duration of the low-power window (i.e., LP111 or LP11) where there is no activity on the communication bus is known and disable the logic elements in the FSM by blocking the timer clock that goes to the FSM during a safe low-power window within the low-power window. When the logic elements in the FSM do not have a clock signal, the logic elements do not flop (i.e., there are no changes from logical ones to zero or vice versa; where such transitions require power consumption), and power is consequently saved. Thus, a “low-power window” as that term is used herein, is for the lowest low-power state allowed by the standard, where there is no traffic on the bus. Excluded from this “low-power window” definition are bridge or intermediate low-power states such as LP001, LP01, LP10, LP000, LP00, or the like.

Because there may be noise or signals on the communication bus that make it look like the bus is in a low-power state (e.g., a false positive), it may be appropriate to create a “safe low-power window” that builds in a margin (e.g., a safety margin or a pessimism margin) after entry into the low-power state and before which the timer clock is not blocked. This margin may also be present at the end of the low-power window so that the timer clock is reconnected to the logical elements of the FSM prior to exit from the low-power window. In exemplary aspects, the margin is twenty percent of the duration of the low-power window, but the margin may be ten percent or even five percent.

FIG. 6 provides a flowchart of a process 600 for determining and implementing the margin. The process 600 begins by entering training (block 602) of the bus. A packet is sent over the bus (block 604). After the end of the packet, the bus enters a low-power window (LP000, LP11) (block 606). A timer or an equivalent counter (not shown) may measure the duration of the low-power window (block 608). The bus exits low-power window (block 610), and a next packet is sent (block 612). A count is incremented (block 614), and the count is compared to a total to see if that is the last count (block 616). If the last count is not reached, the process repeats. Once the last count is reached, a control circuit averages the measurements (block 618) and stores the duration in a register (410, 510) (block 620). Note that the count may be only one test low-power window, but an average of a few low-power windows provides greater accuracy.

With continued reference to FIG. 6, the process 600 continues by calculating a margin (block 622) based on the average low-power window measurement. This margin is subtracted from the low-power window to determine a safe low-power window in the register (410, 510) (block 624). After storing the safe low-power window, the training ends (block 626). Note that in an alternate aspect, the manufacturer knows a priori how they have defined packet frequency and consequent low-power windows. The manufacturer may use this knowledge to program manually the registers 410, 510 accordingly.

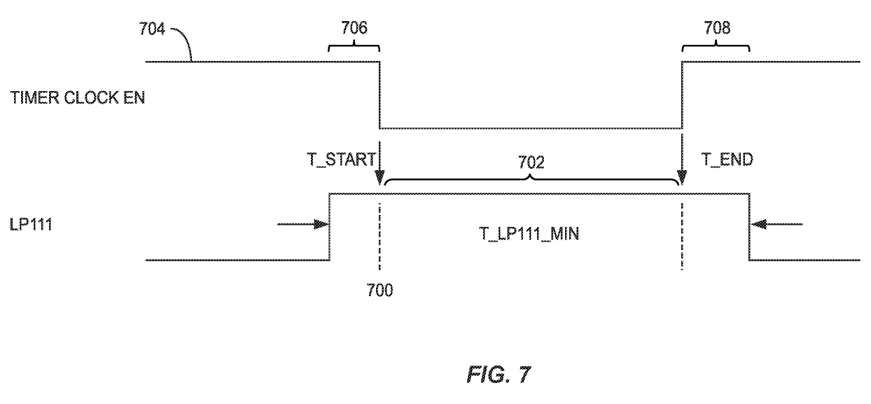

An exemplary low-power window 700 with safe low-power window 702 is illustrated in FIG. 7. During the safe low-power window 702, the timer clock enable signal 704 is low, blocking the timer clock from the FSM 404, 504. However, outside the safe low-power window 702, the timer clock enable signal 704 is high, allowing the timer clock to flop the logical elements in the FSM 404, 504. The safe low-power window 702 differs from the low-power window 700 by pessimism margins 706, 708 at each end. In exemplary aspects, pessimism margins 706, 708 are programmable. Note that the FSM 404, 504 may have an always-on component or may be coupled to another circuit (e.g., another circuit in the application processor 104) that remains active and receives clock signals during the safe low-power window.

Returning to FIG. 6, the process 600 continues with the bus operating normally (block 628). A packet is sent (block 630), and the bus enters a low-power window (block 632) The watchdog timer 408, 508 waits the margin (block 634), such as by setting a timer or a counter and disables the timer clock to the FSM 404, 504 (block 636) The timer clock is enabled to the FSM 404, 504 at the end of the safe low-power window (block 638). The end of the safe low-power window may be determined by a timer or counter in the watchdog timer 408, 508, or the like.

Electronic devices that include communication buses with the power-saving techniques described above, and according to any aspects disclosed herein, may be provided in or integrated into any processor-based device. Examples, without limitation, include a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, laptop computer, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:

1. A device comprising:

a physical layer (PHY) comprising:

a bus interface configured to be coupled to a communication bus; and

a finite state machine (FSM) coupled to the bus interface, the FSM comprising internal logic elements;

the FSM configured to:

responsive to entering a low-power state on the communication bus, disable the internal logic elements and start a timer; and

responsive to the timer expiring, enable the internal logic elements.

2. The device of clause 1, further comprising a timer clock enable circuit configured to receive a timer clock signal and selectively pass the timer clock signal to the FSM.

3. The device of clause 2, wherein the FSM is configured to disable the internal logic elements by blocking the timer clock signal with the timer clock enable circuit.

4. The device of clause 3, wherein the FSM is configured to enable the internal logic elements by passing the timer clock signal through the timer clock enable circuit.

5. The device of any of clauses 1 to 4, wherein the bus interface comprises a CPHY bus interface.

6. The device of any of clauses 1 to 4, wherein the bus interface comprises a DPHY bus interface.

7. The device of any preceding clause, wherein the internal logic elements comprise at least one of an inverter, an AND gate, an OR gate, or a buffer.

8. The device of any of clauses 2 through 7, further comprising a watchdog timer circuit coupled to the bus interface and the timer clock enable circuit, wherein the watchdog timer circuit is configured to detect entry into a low-power state on the communication bus.

9. The device of clause 8, further comprising a register coupled to the watchdog timer circuit, the register configured to store a safe low-power window value for use by the timer.

10. The device of clause 9, wherein FSM is configured to determine the safe low-power window through empirical measurement.

11. The device of clause 9, wherein the safe low-power window is based on a low-power window with a pessimism margin.

12. The device of clause 11, wherein the pessimism margin is twenty percent.

13. The device of any preceding clause, wherein the device is an application processor, a camera, or a display.

14. A mobile communication device comprising:

an endpoint;

a communication bus coupled to the endpoint; and

an application processor coupled to the communication bus;

wherein the endpoint comprises:

a physical layer (PHY) comprising:

a bus interface coupled to the communication bus; and

a finite state machine (FSM) coupled to the bus interface, the FSM comprising internal logic elements;

the FSM configured to:

responsive to entering a low-power state on the communication bus, disable the internal logic elements and start a timer; and

responsive to the timer expiring, enable the internal logic elements.

15. A method of determining a safe low-power window for a communication bus, the method comprising:

detecting entry of the communication bus into a low-power state;

measuring how long the low-power state is maintained on the communication bus to determine a low-power window; and

subtracting a pessimism margin from the low-power window to determine the safe low-power window.

16. The method of clause 15, wherein subtracting the pessimism margin comprises programming the pessimism margin to have a safety margin.

17. The method of clause 15, wherein subtracting the pessimism margin comprises providing a 20% safety margin.

18. The method of any of clauses 15 to 17, further comprising storing the safe low-power window in a register.

19. The method of clause 18, further comprising using the safe low-power window with a watchdog timer circuit.

20. The method of any of clauses 15 to 19, wherein measuring how long the low-power state is maintained on the communication bus, comprises measuring a plurality of low-power states on the communication bus and taking an average.

What is claimed is:

1. A device comprising:
a physical layer (PHY) comprising:
a bus interface configured to be coupled to a communication bus; and
a finite state machine (FSM) coupled to the bus interface, the FSM comprising internal logic elements;
the FSM configured to:
responsive to entering a low-power state on the communication bus, disable the internal logic elements and start a timer; and
responsive to the timer expiring, enable the internal logic elements.

2. The device of claim 1, further comprising a timer clock enable circuit configured to receive a timer clock signal and selectively pass the timer clock signal to the FSM.

3. The device of claim 2, wherein the FSM is configured to disable the internal logic elements by blocking the timer clock signal with the timer clock enable circuit.

4. The device of claim 3, wherein the FSM is configured to enable the internal logic elements by passing the timer clock signal through the timer clock enable circuit.

5. The device of claim 1, wherein the bus interface comprises a CPHY bus interface.

6. The device of claim 1, wherein the bus interface comprises a DPHY bus interface.

7. The device of claim 1, wherein the internal logic elements comprise at least one of an inverter, an AND gate, an OR gate, or a buffer.

8. The device of claim 2, further comprising a watchdog timer circuit coupled to the bus interface and the timer clock enable circuit, wherein the watchdog timer circuit is configured to detect entry into a low-power state on the communication bus.

9. The device of claim 8, further comprising a register coupled to the watchdog timer circuit, the register configured to store a safe low-power window value for use by the timer.

10. The device of claim 9, wherein FSM is configured to determine the safe low-power window through empirical measurement.

11. The device of claim 9, wherein the safe low-power window is based on a low-power window with a pessimism margin.

12. The device of claim 11, wherein the pessimism margin is twenty percent.

13. The device of claim 1, wherein the device is an application processor, a camera, or a display.

14. A mobile communication device comprising:
an endpoint;
a communication bus coupled to the endpoint; and
an application processor coupled to the communication bus;
wherein the endpoint comprises:
a physical layer (PHY) comprising:
a bus interface coupled to the communication bus; and
a finite state machine (FSM) coupled to the bus interface, the FSM comprising internal logic elements;
the FSM configured to:
responsive to entering a low-power state on the communication bus, disable the internal logic elements and start a timer; and
responsive to the timer expiring, enable the internal logic elements.

15. A method of determining a safe low-power window for a communication bus, the method comprising:
detecting entry of the communication bus into a low-power state;
measuring how long the low-power state is maintained on the communication bus to determine a low-power window; and
subtracting a pessimism margin from the low-power window to determine the safe low-power window.

16. The method of claim 15, wherein subtracting the pessimism margin comprises programming the pessimism margin to have a safety margin.

17. The method of claim 15, wherein subtracting the pessimism margin comprises providing a 20% safety margin.

18. The method of claim 15, further comprising storing the safe low-power window in a register.

19. The method of claim 18, further comprising using the safe low-power window with a watchdog timer circuit.

20. The method of claim 15, wherein measuring how long the low-power state is maintained on the communication bus, comprises measuring a plurality of low-power states on the communication bus and taking an average.
